(19) United States
(12) Patent Application Publication
(10) Pub. No.: US 2003/0117054 A1
(43) Pub. Date: Jun. 26, 2003

(54) Cathode structure, and production method therefor and electron gun and cathode ray tube

(76) Inventors: Makoto Maeda, Kanagawa (JP); Tomohisa Asano, Tokyo (JP); Akihiro Kojima, Kanagawa (JP); Yoshinori Yamada, Tokyo (JP); Tadakatsu Nakadaira, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/220,020

(22) PCT Filed: Dec. 26, 2001
(86) PCT No.: PCT/JP01/11494

(51) Int. Cl. H01J 1/14; H01J 1/00; H01J 19/06

(52) U.S. Cl. 313/310; 313/311; 313/346 R

(57) ABSTRACT

To obtain a cathode electrode (a cathode structure) where the electron beam spot diameter or size is reduced, the cathode driving voltage is lowered and the cathode current is stabilized for a long period, a recess or a region which does not radiate electron beams is formed near the central portion or near the outer circumference portion of an electrode radiation substance 9 of a cathode electrode 1, and hollow electron beams are obtained related to a cathode electrode, its manufacturing method, an electron gun and a cathode-ray tube.

### TECHNICAL FIELD

The present invention relates to a cathode structure, a method of manufacturing the same, an electron gun and a cathode-ray tube preferably used in a picture and character display device of color television receivers or the like.

### BACKGROUND ART

Recently, the cathode-ray tube (hereinafter referred to as CRT) used in the picture and character display device as an information terminal is demanded to have higher brightness and higher resolution. Electron beams of the electron gun are required to be focused on smaller areas.

Technical efforts for higher resolution of electron gun are continuously concentrated on development of large-aperture lens and multi-stage convergence lens.

However, use of large-aperture lens causes to increase the power consumption of the deflection yoke and use of multi-stage convergence lens requires setting of many different voltages in multiple electrodes.

One of the systems to solve such technical problems is a multiplex beam system which is disclosed, for example, in a Japanese Patent National Laid-open Publication No. 6-518004.

The above mentioned multiplex beam system relates to an electron gun designed to drive plural electron beams responsive to one input signal and more specifically, for example, in case of a color CRT each of red, green and blue fluorescent phosphors of fluorescent screen is usually illuminated by one electron beam, but in that multiplex system a plurality of electron beams are used to share the load, the current amount of each electron beam is lessened, and by converging the beams, a larger current is concentrated on one spot of the fluorescent screen, so that the brightness and definition may be enhanced.

Further, in order to reduce the size of electron beam an area-restricted cathode is proposed in which the electron beam radiation area of the cathode structure is limited (IDW, 1999, pages 541 to 544).

FIGS. 11A and B are main side sectional views of an electron gun near the cathode structure disclosed in the above mentioned publication document and FIG. 11A shows an isolator type electron radiation substance 9 coated on a base metal 8a disposed in a sleeve which is comprised in a cathode structure where the diameter of the electron radiation substance 9 is made small like 100 μm when coated thereon. In case of FIG. 11B, the top of an electron radiation substance 9 covering the entire region of the top of the base metal 8a is coated with a shielding member 18 for shielding electrons where an aperture 18b of 115 μm in diameter is formed in the center of the shielding member 18, and the electron beam is restricted and radiated from the area of the aperture 18b.

The multiplex beam system explained above as prior art involves the following problems:

(1) The electron gun electrode structure which controls multiple electron beams becomes complicated.

(2) The total electron beam diameter increases and the effect of multiplex beams is lost unless plural electron beams are concentrated precisely in the entire region of the CRT screen.

On the other hand, the area-restricted cathode disclosed in the publication document of IDW involves the following problems:

(3) Electron radiation area of the electron radiation substance becomes small and concentrated in the center, so that the concentrated negative electrons repulse each other and the electron beam diameter becomes widened.

(4) With respect to the electron orbit of the central portion of the electron beams and the electron orbit of the outermost part of the electron beams, there remains the problem of deviation of electron beam focus positions at the fluorescent screen (spherical aberration) after they pass the electron gun main electron lens system.

(5) In case of high current driving, saturated current density occurs near the central axis of the electron radiation substance due to the small diameter thereof and the electron supply capacity becomes lowered.

The invention is devised to solve these problems mentioned above and the problems which the invention solves are to reduce the spot size of the electron beam at the fluorescent screen of the CRT and to lessen the current density load of electron radiation substance of the cathode electrode such that a cathode structure, its manufacturing method, electron gun and cathode-ray tube where the cathode driving characteristic in the high current region is improve are obtained.

### DISCLOSURE OF THE INVENTION

A first cathode structure of the invention is characterized in that hollow electron beams are emitted in a condition where the current density of the entire region, near the central axis or near the outer circumference of electron beams radiated from the top of an electron radiation substance of a cathode electrode is reduced.

A second cathode structure of the invention is characterized in that an electron radiation substance 9 of a cathode electrode is formed cylindrical and hollow electron beams are emitted from the ring-shaped upper portion other than an opening 9a drilled in the central portion of the cylindrical portion or the cylindrical side face of the cylindrical shape.

A third cathode structure of the invention is characterized in that a recess 9m is provided near the central portion of the top of an electron radiation substance, a swollen protrusion is formed surrounding the recess 9m, and hollow electron beams are emitted from the top of the protrusion 9k.

A first manufacturing method of cathode structure of the invention is characterized by comprising a step of forming a uniform electron radiation substance 9 on electron radiation forming members 8 and 8a in advance, and a step of removing or shielding near the central portion or near the outer circumference portion of said electron radiation substance 9 by irradiating laser beams, by mechanical operation 15, by impinging ions 16 or by metal vapor 17, thereby forming a region which does not radiate electrons at said electron radiation substance 9.

A second manufacturing method of cathode structure of the invention is characterized by comprising a step of disposing a shielding members 18 and 18a near the central portion or near the outer circumference portion of an electron radiation substance forming members 8 and 8a, a step of applying an electron radiation substance 9 on the electron radiation substance forming members 8 and 8a, and a step of removing the electron radiation substance 9 at said shielding member 18 or on said shielding member 18a, thereby forming a region which does not radiate electrons at said electron radiation substance.

A third manufacturing method of cathode structure of the invention is characterized by comprising a step of forming an emitter impregnate type electron radiation substance on an electron radiation substance forming members 8 and 8a, and a step of disposing a substance 24 which does not impregnate the emitter near the central portion or near the outer circumference portion of said emitter impregnate type electron radiation substance 9, thereby forming a region which does not radiate electrons in said emitter impregnate type electron radiation substance 9.

An electron gun 41 which comprises at least a cathode electrode, a grid electrode s (G₁ to G₅) 10, 11, 12, 42, 43, 44 and a convergence electrode 46 of the invention is characterized in that hollow electron beams 13 are emitted in a condition where the current density of the entire region, near the central axis or near the outer circumference of electron beams radiated from the top of an electron radiation substance 9 of the cathode electrode 1 is reduced.

A CRT which comprises at least an electron gun 41 having a cathode electrode of the invention is characterized in that in hollow electron beams 13 are emitted in a condition where the current density of the entire region, near the central axis or near the outer circumference of electron beams radiated from the top of an electron radiation substance 9 of the cathode electrode 1 is reduced.

According to the cathode structure, its manufacturing method, electron gun and cathode-ray tube of the above mentioned invention, the crossover diameter can be reduced and the electron beam spot diameter at the fluorescent screen can be reduced. The convergence can be attained in smaller size area than that of the conventional electron gun and damage probability of the cathode due to discharge of ions and the like can be lowered. Further, as compared with the restricted cathode, electrons can be radiated from a wider region, the current density load in the cathode is lessened, a longer life is expected and in addition the cathode driving characteristic in the high current region can be improved.

### BRIEF DESCRIPTION OF DRAWINGS

FIG. 1A is a schematic perspective view of a cathode structure of the invention;

FIG. 1B is a sectional view taken along the line A-A′ to the direction of the arrow in FIG. 1A;

FIG. 1C is a side sectional view of a cathode structure showing other embodiment of the invention;

FIG. 2A to FIG. 2D are side sectional views of cathode structures showing various modified examples of manufacturing methods of cathode structures of the invention;

FIG. 3A to FIG. 3D are side sectional views of cathode structures showing various modified examples of other manufacturing methods of cathode structures of the invention;

FIG. 4A to FIG. 4(E) are perspective views of cathode structures showing various modified examples of a different manufacturing methods of cathode structures of the invention;

FIG. 5 is a side sectional view showing other embodiment of a cathode structure of the invention;

FIG. 6A is a plan view of the cathode structure shown in FIG. 5;

FIG. 6B to FIG. 6E are sectional views taken along the line A-A′ to the direction of the arrow in FIG. 6A showing various shapes of protrusion of electron radiation substance of the cathode structure;

FIG. 7A to FIG. 7D are side sectional views of cathode structures showing different embodiments of cathode structures of the invention (FIG. 7A and FIG. 7D), plan view of electron radiation substance (FIG. 7B), and sectional view taken along the line B-B′ to the direction of the arrow in FIG. 7B (FIG. 7C);

FIG. 8 is a partially cut-away perspective view of electron gun and CRT of the invention;

FIG. 9 is an explanatory diagram showing crossover point of electron beams of the invention and crossover point of conventional electron beams;

FIG. 10A and FIG. 10B are explanatory diagrams showing improvement of spherical aberration in the main lens of the invention;

FIG. 10C is a graph showing simulated results of driving voltage (Ed) in relation to cathode hollow diameter; and

FIG. 11A and FIG. 11B are side sectional views of conventional area-restricted cathode structures.

### BEST MODE FOR CARRYING OUT THE INVENTION

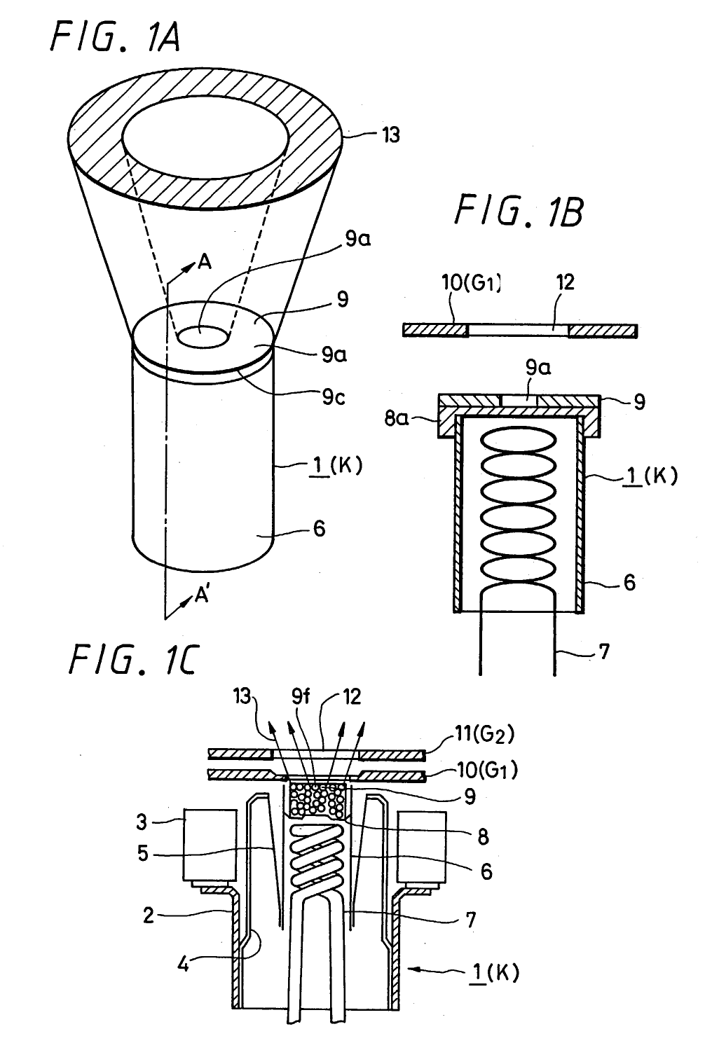

The cathode structure, its manufacturing method, electron gun, and cathode-ray tube of the invention are described in detail below with reference to FIG. 1 to FIG. 7.

FIG. 1A and FIG. 1B show a cathode structure (hereinafter referred to as cathode electrode K) 1 applied in a circular hole type electron gun, in which a flat or dish formed base metal 8a made of Ni alloy or the like is welded on a first sleeve 6 made of a cylindrical metal, and an electron radiation substance 9 made by blending a mixture of BaCo₃, SrCo₃, CaCo₃, solid solution (Ba_{1-x-y}, Sr_{z}, Ca_{y}) Co3 and binder is applied by spraying or other method on this base metal 8a. The electron radiation substance 9 is initially a carbonate type which is transformed into an oxide type when heated in vacuum.

The first sleeve 6 incorporates with a heater 7 for heating the cathode electrode 1 to the operating temperature. The cathode electrode 1, a first control electrode (hereinafter referred to as G₁) 10, and a second control electrode (hereinafter referred to as G₂, see FIG. 1C) 11 which composes a three-part electrode structure are disposed at specific intervals in the electron beam radiation direction and a circular aperture 12 is drilled in the center of G₁ 10 and G₂ 11.

The cathode electrode 1 of the invention is has, as shown in FIG. 1A and FIG. 1B, a portion without the electron radiation substance at the central portion, that is, an aperture 9a is drilled and the electron radiation substance 9 releases hollow electron beams 13 from a ring portion 9b and/or circular section 9c thereof.

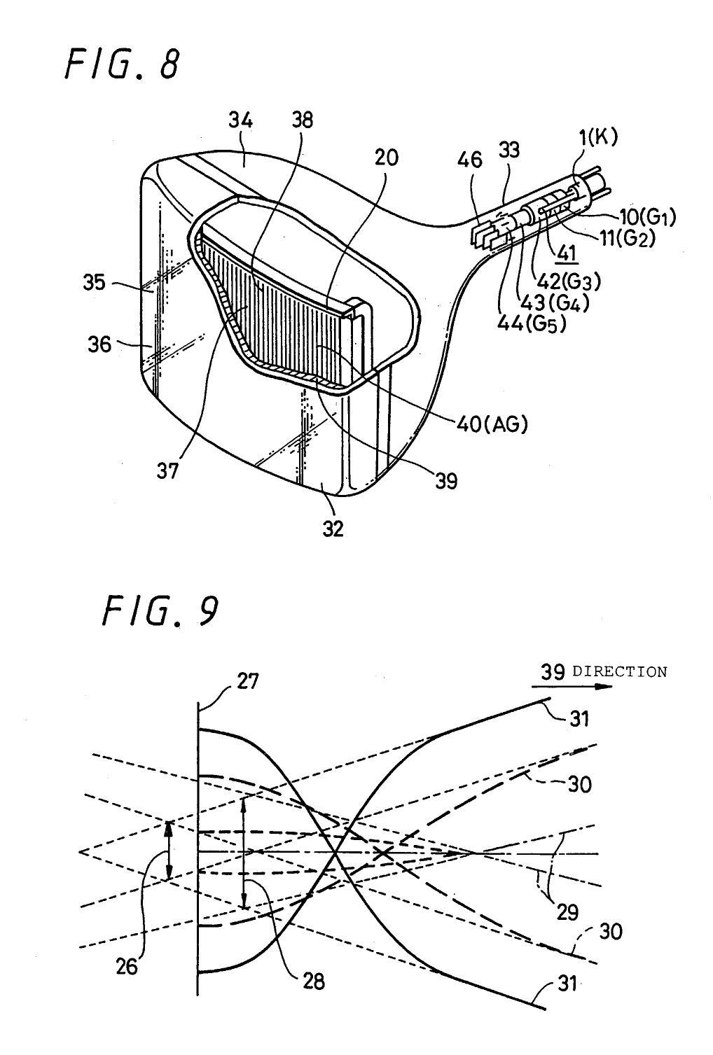

By using such cathode electrode 1, when controlling rolling current by G₁ 10 and G₂ 11, concentric hollow electron beams 13 as shown in FIG. 1A is radiated from the top of the electron radiation substance 9, its shape is maintained and reaches a color fluorescent screen 39 of a CRT 32 as shown in FIG. 8 while its shape is maintained and an image is focused thereon.

The cathode electrode 1 shown in FIG. 1C shows an impregnate type structure, which are known as having various types. In FIG. 1C, same parts shown in FIG. 1A and FIG. 1B are referred to the same reference numerals and repeated explanation thereof is omitted. And specifically at the upper side of the first sleeve 6 which contains the heater 7 inside, a U-shaped heat resistive cup 8 for accommodating the electron radiation substance 9 is welded. The impregnate type cathode electrode 1 is formed by impregnating electron radiation substance 9 such as BaO, CaO, or Al₂O₃ to a porous base material such as porous tungsten disk.

A second sleeve 4 is composed of a cup-shaped metal having an opening drilled at the bottom and the first sleeve 6 is fixed to the second sleeve 4 by means of a ribbon-shaped strap 5. A cylindrical sleeve holder 2 is welded to the second sleeve 4, an insulating member 3 of ceramic disk or the like for insulating an electron gun and the cathode electrode 1 is fixed on the sleeve holder 2.

To obtain a portion without electron radiation substance near the center of the impregnate type electron radiation substance 9, pores in the porous base material are filled by polishing or by laser beam radiating before emitter impregnation and a low porosity setting region, that is, a poreless portion 9f where the emitter impregnated substance melted and lost is formed.

Even in such configuration of the impregnate type cathode electrode, a concentric hollow electron beam 13 can be radiated from the top of the electron radiation substance 9.

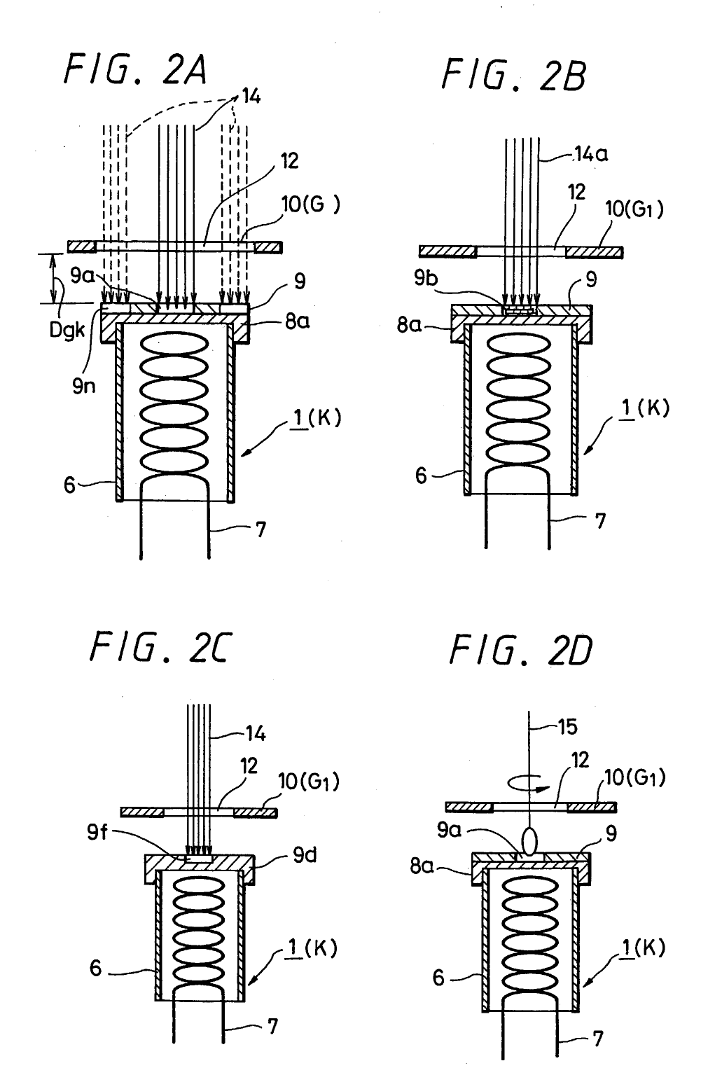

A manufacturing method of setting a region without electron beam radiation onto the electron radiation substance 9 of the cathode electrode 1 as mentioned above is explained in detailed with reference to FIG. 2 to FIG. 7.

FIG. 2A shows an embodiment of the cathode electrode 1 of the invention in which the cathode electrode 1 where the electron radiation substance 9 is formed on the base metal 8a in advance is assembled with G₁ 10. In particular, setting the distance d_{gk} from the top of the electron radiation substance 9 to the lower side of the G₁ 10 and the aperture of the G₁ 10 same as those in the actual electron gun and on the basis of the aperture 12 of the G₁ 10, the laser beams 14 is irradiated near the central position of the specified setting region of the electron radiation substance 9 and/or near the outer circumference while leaving the electron beam radiation portion in a ring-shaped area as indicated by broken lines. By such radiation of laser beam 14, the electron radiation substance 9 near the center and/or near the outer circumference is scattered and lost and by forming an opening 9a or ring-shaped outer circumference 9n which do not radiate electron beams, a concentric electron radiation substance 9 is formed. Thereafter, the electron gun is assembled as usual.

FIG. 2B shows other embodiment of the cathode electrode 1 of the invention, in which an electron radiation substance 9, for example, BaCo₃ is formed on the base metal 8a in advance. At the next step, the cathode electrode 1 and G₁ 10 are assembled in correct and precise position and disposed in the atmosphere of high humidity and a relatively weak laser beam 14a is irradiated on the basis of the aperture 12 of the G₁ 10 to heat, for example, near the center of the setting region of the electron radiation substance 9 of the cathode electrode 1 (the following explanation refers to a case of forming a region which does not radiate electron beams near the center).

By such laser radiation and heating, the electron radiation substance 9 is chemically changed to a hydroxide 9b and a region which does not radiate electron beams (hydroxide region 9b) is formed.

Usually the electron radiation substance 9 is handled like a carbonate in the atmosphere, the electron gun is inserted into the CRT and the electron radiation substance 9 is activated by thermal reduction reaction in the vacuum. If changed to a hydroxide before the exhaust, this activation does not take place. Therefore, electron beams 13 are not radiated from the portion of the hydroxide 9b. The subsequent assembling of the electron gun is done by the same way according to the ordinary method.

FIG. 2C shows a further different embodiment of the cathode manufacturing method according to the invention in which the cathode electrode 1 and G₁ 10 are assembled correctly in advance, the laser beam 14 is irradiated on the basis of the aperture 12 of the G₁ 10, and the emitter impregnated substance 9d of the emitter impregnate type electron radiation substance 9 is melted and a poreless portion 9f where the pores in the porous base material (tungsten) are lost is set in a specified setting region, for example, near the center, so that a region which does not radiate electrons can be formed in the emitter impregnated substance 9d. The subsequent assembly of the electron gun is done according the same way as usual.

FIG. 2D shows a still further embodiment of the cathode manufacturing method according to the invention in which the cathode electrode 1 and G₁ 10 are assembled correctly in advance, the electron radiation substance 9 is applied with mechanical cutting by a micro grinder 15 or the like on the basis of the G₁ 10 and, for example, the vicinity of the center is removed and an opening 9a which does not radiate electrons is drilled, thereby a ring-shaped electron radiation substance 9 is formed, and the subsequent assembly of the electron gun is done according to the same way as usual.

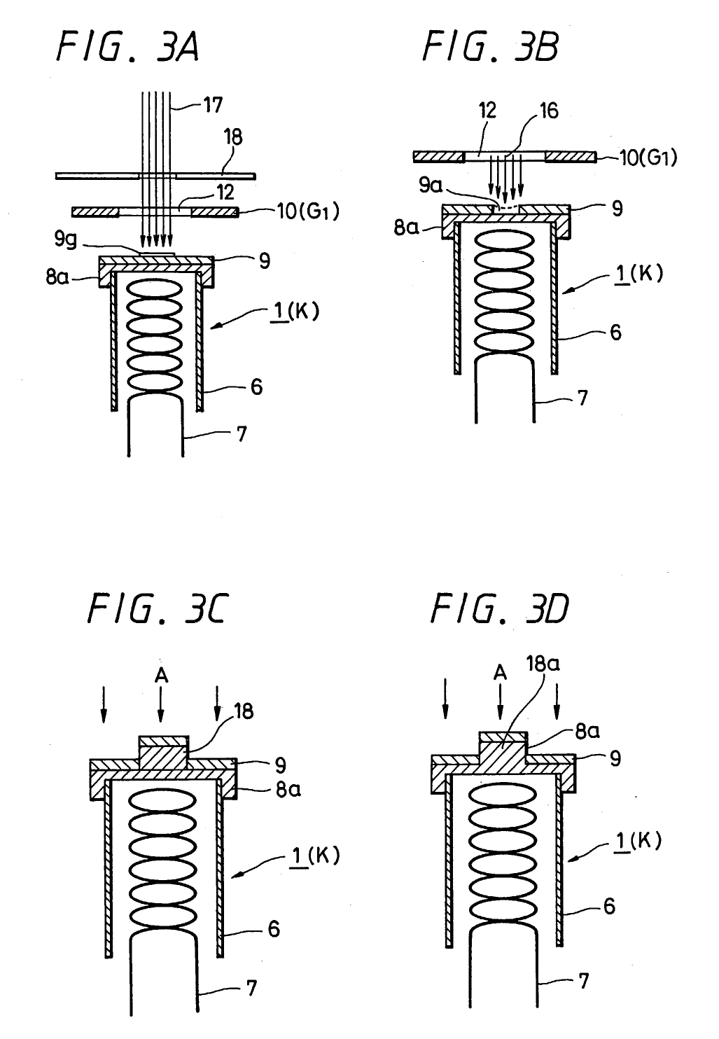

FIG. 3A shows a further different embodiment of the cathode manufacturing method according to the invention in which the cathode electrode 1 and G₁ 10 are assembled correctly in advance and on the basis of the G₁ 10, a shielding member 9g such as metal deposition film which is an emission killer substance such as gold is formed in the specified setting region on the electron radiation substance 9, for example, by metal vapor 17 through an opening drilled in a mask 18 at the central position, and thereby a ring-shaped electron radiation substance 9 having a metal deposition film which does not radiate electrons is formed. The subsequent assembly of the electron gun is done by the same way as usual.

FIG. 3B shows a further different embodiment of the cathode manufacturing method according to the invention in which after completely assembling the electron gun of the CRT, each control electrode of the electron gun is controlled in low vacuum to generate ions 16 intentionally and a specified surface setting region of the electron radiation substance 9, for example, the central portion of the electron radiation substance 9 is scattered and burnt out by ion impingement and thereby a ring-shaped electron radiation substance 9 is formed. In the ordinary circular hole type electron gun, the electric field intensity is highest at the surface of the electron radiation substance 9 of the cathode electrode 1 near the central axis of the aperture the G₁ 10, ions are likely to be generated in this area and by making use of this tendency, an opening 9a which does not radiate electron beams is formed.

In the above mentioned various embodiments, when obtaining the cathode electrode, electron gun or CRT having a distribution region which does not radiate electrons at the electron radiation substance 9, unless the position is precisely set among the control electrodes, in particular, between the G₁ 10 and cathode electrode 1, coma or astigmatism increases and the beam spot diameter at the fluorescent screen becomes larger, and the resolution deteriorates, and therefore, for example, in the cylindrical symmetrical electron gun, hollow beams cannot be formed unless the higher precision in the axial deviation between the center of the opening 9a on the top of the electron radiation substance 9 of the cathode electrode 1 and the center of the aperture 12 of the G₁ 10 is obtained and higher precision in the distance d_{gk} between the surface of the cathode electrode 1 and the G₁ 10 is obtained, and hence it is required to be based on or relay upon the aperture 12 of the G₁ 10.

Moreover, by employing a technique of highly precisely positioning using image processing or the like when assembling the cathode electrode 1 with other electron gun electrodes, the following cathode and cathode manufacturing method can be also adopted.

That is, FIG. 3C shows a further different embodiment of the invention, and in case of FIG. 3C when applying or plating the electron radiation substance 9 onto the base metal 8a of the cathode electrode 1 from the direction of an arrow A, a disk-shaped shielding member 18 for shielding the specified setting region is placed, for example, near the center of the base metal 8a and the electron radiation substance 9 is placed, and thereby a ring-shaped electron radiation substance 9 is formed around the base metal 8a, and by removing the shielding member 18 from the base metal 8a and a region of the ring-shaped electron radiation substance 9 which does not radiate of electron beams is formed.

FIG. 3D shows a further different embodiment of the invention, in which a convex-shaped base metal which has a convex portion near the center of the base metal 8a is formed, and a coating type electron radiation substance 9 is plated from the direction of an arrow A, and by removing the electron radiation substance 9 on the convex portion which forms a shielding member 18a, the setting region of the ring-shaped electron radiation substance 9 which does not radiate electron beams is formed.

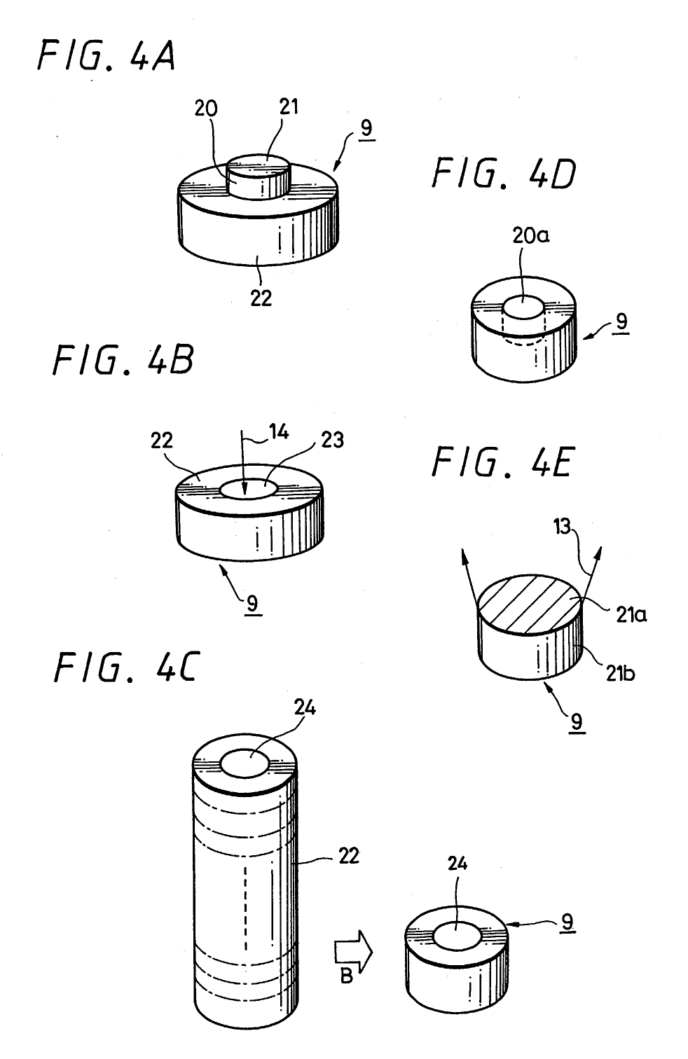

FIG. 4A is a perspective view showing other embodiment of electron radiation substance 9 used in the cathode electrode of the invention in which a porous base material 22 such as porous tungsten composed of impregnate type tungsten powder sinter is formed as a cylinder having a convex portion, that is, a protrusion 20 having a ring shape on the peripheral top leaving the central portion is formed and porous gaps of the top surface of the protrusion 21 are filled up by mechanical cutting and polishing, and a setting region of low porosity which does not radiate electron beams is formed.

By impregnating the emitter of an electro-emitting substance such as Ba, a region which does not radiate electron beams is formed on the top 21 of the protrusion 20 by preventing impregnation of emitter from the top 21 of the protrusion 20.

FIG. 4B shows a further different embodiment of the invention in which a porous base material 22 such as porous tungsten disk composed of impregnate type tungsten powder sinter is formed as a cylinder and in order to form a specified setting region 23 which does not radiate electron beams, for example, a laser beams 14 is irradiated near the center of the porous base material 22, and the setting region 23 of the porous base material 22 is melted to fill the porous gaps and the porous base material 22 of low porosity is obtained. Then, by impregnating an emitter for impregnation such as Ba, the electron radiation substance 9 where a region which does not radiate electron beams is formed in the setting region 23 is obtained.

FIG. 4C shows further embodiment of impregnate type cathode manufacturing method according to the invention. In FIG. 4C, in a hollow space of a cylindrical porous base material 22 made of tungsten powder sinter, a portion such as tungsten metal column 24 which is not impregnating emitter is formed integrally as one body. In this case, the shaft of the tungsten metal column 24 is made as an axis and tungsten powders are press-sintered therearound. Consequently, this cylindrical porous base material 22 is cut into round slices and as shown by an arrow B, disk-shaped body is formed, and by impregnating the emitter such as Ba, the electron radiation substance 9 with impregnated substance except the portion of the tungsten metal column 24 is obtained.

FIG. 4D and FIG. 4E show further embodiments respectively of the electron radiation substance 9 of the cathode electrode 1 according to the invention. That is, if the boundary of the setting region 23 which does not radiates electrons at the surface of the electron radiation substance 9 is clear, highly precise positioning is possible. To realize this, as shown in FIG. 4D, a hole 20 a by spot facing way is drilled in the central position on the top of the electron radiation substance 9, and by the removed effect of the electron radiation substance 9 and the electric field intensity lowering effect in the portion of the hole 20a by spot facing way, a region which does not radiate electrons can be formed. And as shown in FIG. 4E, a hollow electron beams 13 can be radiated not from the top 21a of the electron radiation substance 9, but from the peripheral side 21b of the disk-shaped body for emitting the electron beams 13.

In the above mentioned cathode electrode, the region such as the opening 9 a which does not radiate electrons and formed near the center of the electron radiation substance 9 is explained as a circular shape, but when the shape of the aperture 12 drilled in the G₁ 10 and G₂ 11 is such a shape as elliptical, rectangular, square or polygonal, the shape of such setting region may be formed to match or coincide therewith.

In the above mentioned cathode electrode 1, the region which does not radiate electron beams is formed near the central axis of electron beams of the electron radiation substance 9, but a recess may be formed in the central axis of electron beams radiation of the cathode electrode 1, and a protrusion may be formed by swelling the peripheral area so as to surround the recess.

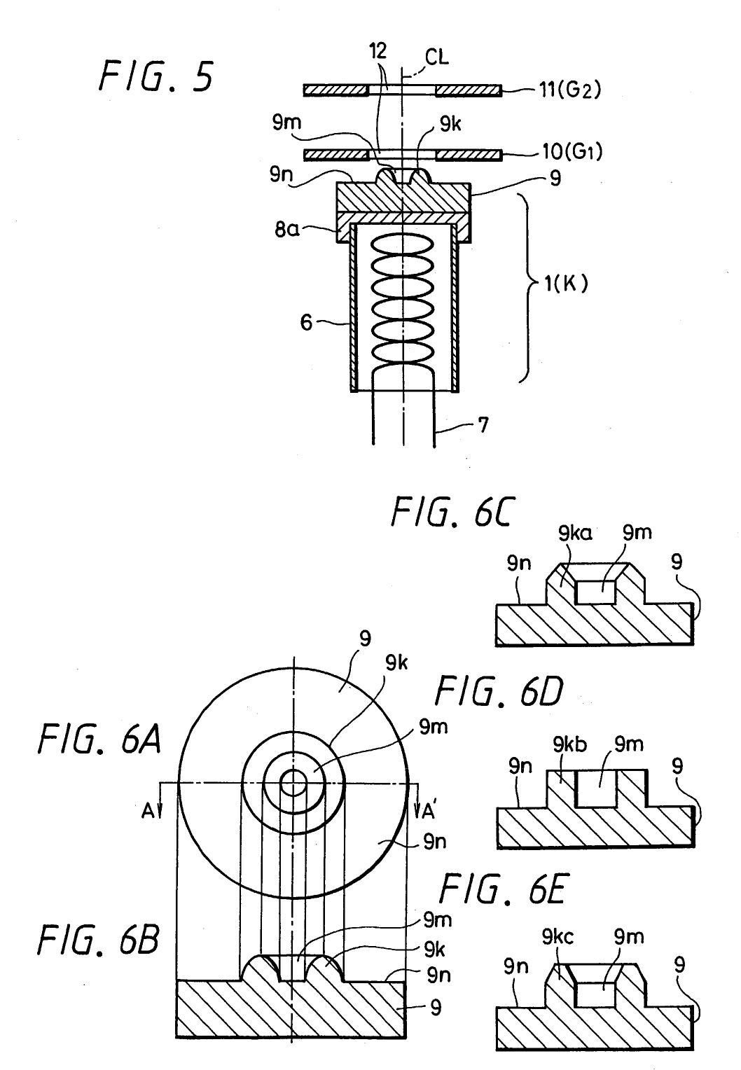

FIG. 5 shows a side sectional view of such cathode electrode 1 in which same parts as in the cathode electrode 1 shown in FIG. 1 to FIG. 3 are referred to the same reference numerals and duplicate explanation is omitted.

In FIG. 5, a recess is formed near the electron beam axis (central axis) CL for radiating electron beams in the cathode electrode 1 and a protrusion 9k is formed by swelling so as to surround this recess 9m. That is, in FIG. 5, a ring-shaped protrusion 9k is formed centering around the electron beam axis CL on the top of the electron radiation substance 9. Electron beams are not radiated from the recess 9m surrounded by this protrusion 9k and not from the outer circumference 9n out of the ring-shaped protrusion 9k up to the periphery of the electron radiation substance 9 and therefore, electron beams are radiated from the protrusion 9k instead such that a current density distribution of the electron beams at the cross sectional plane of the radiated beams of the cathode electrode 1 is formed in the center of the electron beams where to generate a low hollow beams 13.

An example of preparing an impregnate type electron radiation substance 9 is explained with reference to FIG. 6A to 6E.

FIG. 6A is a plan view of the electron radiation substance 9 which is same as FIG. 5, and FIG. 6B to FIG. 6E are cross sectional views taken long the line and to the arrow direction of A-A′ in FIG. 6A, showing various shapes of leading edge of the protrusion 9k.

In a manufacturing method of electron radiation substance 9, first tungsten powder and binder together are pressed in a die and various shapes as shown in FIG. 6A to FIG. 6E are formed and then they are sintered. After sintering, the tungsten powder sinter is conducted with cutting operation by a grinder except for the top of the protrusion 9k, and further the tungsten powder sinter is conducted with cutting operation by shot blasting and manufacturing various shapes such as a round leading edge (top) of the ring-shaped protrusion 9k as shown in FIG. 6B, a sharp edge 9ka as shown in FIG. 6C, a flat edge 9kb as shown in FIG. 6D and a chamfered top 9kc where the vicinity of the top is chamfered as shown in FIG. 6E.

From the designing point of view, if the height of the protrusion 9k is limited, pores in the tungsten sinter can be filled up to prevent release of electrons by applying laser to the recess 9m in the central portion of the electron radiation substance 9 and to the outer circumference 9 of the protrusion 9k for melting operation.

Not limited to the impregnate type, a cathode of oxide spraying type or the like may be also formed in a specified ring shape physically by grinding or shot blasting. Further, it may be also formed in the same manner as in FIG. 1 to FIG. 3.

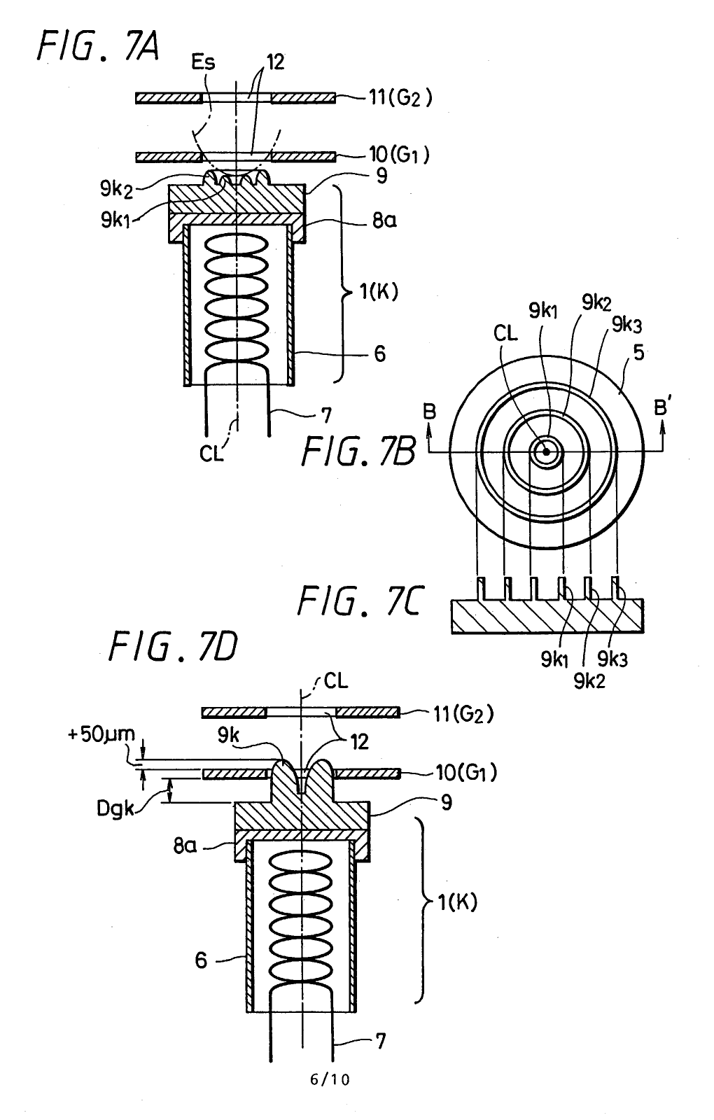

FIG. 7A to FIG. 7C show other impregnate type cathodes further advanced from FIG. 5. FIG. 7A is a plan view of electron radiation substance 9 which has a double structure of ring-shaped protrusions, FIG. 7B similarly shows a triple structure of ring-shaped protrusions, FIG. 7C is a sectional view taken along the line B-B′ and seen to the direction of the arrow in FIG. 7B and FIG. 7D is a side sectional view showing a modified example of cathode electrode of FIG. 6A.

In the case of FIG. 7A, double ring-shaped concentric protrusions 9k₁ and 9k₂ are formed where the protrusion height is lower for the first ring-shaped protrusion 9k₁ and higher in the second ring-shaped protrusion 9k₂ and it is designed such that the electric field intensity Es at the swelling peaks becomes equal in a specified cathode current region. In the single ring shape, mean while, if a design is employed emphasizing on the effect of the hollow electron beam in the high current region, the ring diameter becomes larger and consequently the electron beam diameter increases in the low current region. To the contrary, if a design is employed asking for the hollow electron beam effect from the low current region, the ring diameter becomes smaller and it decreases the hollow electron beam effect in large current and decreases the operating effect for smaller current density than that in an ordinary cathode.

Owing to these reasons, when a double (multiple) ring shape is formed, a current is generated from the inside ring-shaped protrusion for the low current region and a current is also generated from the outside ring-shaped protrusion beyond a certain current value and therefore, the hollow electron beam effect and a reducing effect of cathode current generating density by expanding the electron radiation generating region can be obtained for the wider current region. The distance of the protrusions 9k₁ and 9k₂ from the cathode electron beam central axis CL and the height of the protrusions 9k₁ and 9k₂ are designed on the basis of the electric field intensity Es of the protrusions 9k₁ and 9k₂ controlled by the cathode electrode 1, G₁ 10 and G₂ 11. That is, they can be freely designed depending on what drive voltage-cathode current characteristic is needed or what drive voltage-electron beam diameter characteristic is needed.

FIG. 7B and FIG. 7C show a triple ring structure in which the positions and heights of protrusions 9k₁, 9k₂ and 9k₃ can be designed freely same as those in FIG. 7A. Of course, in addition to such triple ring structure other multiple concentric structures can be employed.

In FIG. 7D, the height of the ring-shaped protrusion 9k concentrically formed on the top of the disk-shaped electron radiation substance 9 of the cathode electrode 1 shown in FIG. 5A is made higher than the distance D from the top of the electron radiation substance 9 to the lower side of the G₁ 10 and more specifically in the example in FIG. 7D, the protrusion 9k extends or projects about 50 μm from the aperture 12 of the G₁ 10. Of course, in this configuration the outer diameter of the protrusion 9k is selected smaller than the diameter of the aperture 12 of the G₁ 10. Those of plural ring shapes shown in FIG. 7A and B can be similarly projected, too.

As mentioned above, by extending the protrusion 9k to the direction of the aperture 12 of the G₁ 10 the potential gradient to the cathode axial direction around the protrusion 9k can be made moderate as compared with the case where the protrusion is not projected when turning off (cutting off) the cathode current. As a result, a greater cathode current can be generated by a smaller cathode potential change (drive voltage change).

Configurations of an electron gun and a cathode ray tube using the cathode electrode 1 obtained by the manufacturing methods mentioned above are explained with reference to FIG. 8.

In FIG. 8, a tube body 35 of a CRT 32 is composed of a glass panel 36 and a funnel 38 made of a funnel-shaped glass, a color selecting electrode plate (color selecting mask) 37 stretched on a frame 20 opposite to a color fluorescent screen 39 formed inside the panel 36 has a grid element 38 in its longitudinal direction, a color selecting mechanism (aperture grille AG) 40 is constructed, the AG 40 is fixed inside of the tube body 35, and an electron gun 41 is disposed in a neck portion 33 opposite to the AG 40.

This color CRT 32 comprises plural cathode electrodes, for example, red, green and blue cathodes arranged in an inline form. For electron beams taken out from these cathodes, three-pole electrodes are composed of common G₁ 10, G₂ 11 and G₃ 42, and a main electron lens system is composed together with a focus electrode G₄ 43 and a second positive electrode G₅ 44. A converging deflector 46 such as a converging cup is provided in the rear side of G₅ 44 and further, horizontal and vertical deflecting yokes not shown are provided outside of the neck 33 where each beam is deflected horizontally and vertically.

In the cathode electrode 1, its manufacturing method, the electron gun and the CRT mentioned above, the operation and effects of using the hollow beams are explained below.

(1) When controlling the current by the cathode electrode 1 in the three electrodes arrangement such as in the electron gun 41 of the CRT 32, crossover is generated between the cathode electrode 1 and G₁ 10 and it becomes the object point in the principal electron lens system to be composed or disposed later. The crossover diameter and divergence angle seen from the principal electron lens system are closely related with the electron beam diameter on the fluorescent screen 39.

Supposing the electron beam spot diameter on the fluorescent screen 39 is ø, the relation shown in the following equation (1) is established:

ø=M·øc+M·Cs·θ³+Rep. (1)

where M is the image multiplying factor of the main electron lens, Cs is the spherical aberration of the main electron lens system, øc is the crossover diameter seen from the principal electron lens system, θ is the divergence angle seen from the main electron lens system, and Rep is the repulsive effect between flighting electrons.

As shown in FIG. 9, speaking of the electron beam orbit radiated from the cathode surface 27 of the cathode electrode 1, the crossover point thereof comes to the G₁ 10 side further closer for the electron beam orbit 29 from the cathode surface 27 near the center of the electron beam as compared with the electron beam trajectory 31 from the outermost part of the cathode, and then with respect to the position of the crossover diameter 28 seen from the main electron lens system when the hollow electron beams determined by the electron orbit near the central axis are not radiated, the crossover diameter 26 seen from the main electron lens system of the cathode radiating the hollow electron beam comes near the cathode side and becomes smaller, and the crossover diameter øc is reduced depending upon the equation (1), so that the electron beam spot diameter or size on the color fluorescent screen 39 can be reduced.

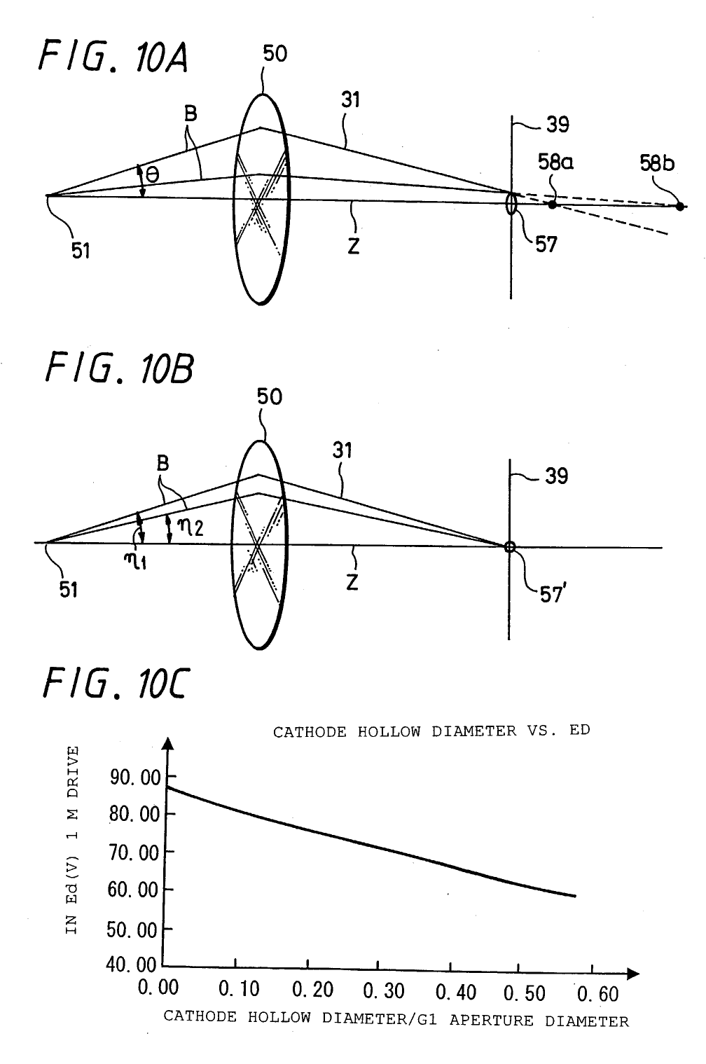

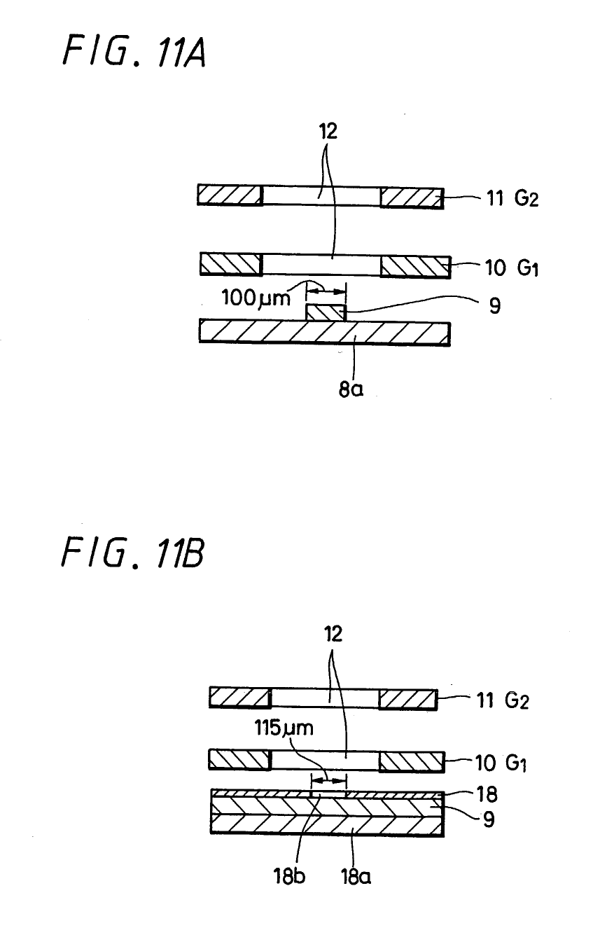

(2) Next the improvement of spherical aberration of the principal electron lens system is explained with reference to FIG. 10A and FIG. 10B.

In FIG. 10A, the angle θ formed between the electron beam B entering a main lens 50 from a crossover point 51 and the electron beam central axis Z goes or distributes in a range of 0 to θ and therefore, the electron beams B leaving the main lens 50 intersect the electron beam central axis Z at different points 58a and 58b, effects of the spherical aberration are conducted, and the size of the spot 57 on the color fluorescent screen 39 becomes larger.

On the other hand in the case of FIG. 10B, the electron beams B from the crossover point 51 goes only in a range of angle η₁-η₂, supposing the angle between the electron beam central axis Z and electron beams B in the hollow area to be η₂ and the angle between the electron beam central axis Z and the ring-shaped outer circumference is η₁ where since there is no electron beams B in the range of angle η₂ near the electron beam central axis and then electrons do not repulse each other in the narrow range, effects of spherical aberration becomes small, and a favorable spot 57′ can be obtained.

Namely, in consideration of the electron orbit at the central portion of the electron beams and the electron orbit at the outermost part of the electron beams, the focus positions are deviated due to spherical aberration of the main electron lens system of the electron gun and the focus positions become closer to the electron gun side for the outer side electron beams. In case of hollow electron beams, since there is no electron orbit passing the electron beam central portion, the difference between the focus positions becomes smaller and the convergence can be realized in a smaller area than those of the conventional electron gun, so that the electron beam spot size on the color fluorescent screen 39 can be reduced.

In an ordinary structure, the current density is high near the electron beam central axis and the diameter of electron beam flux increases until reaching the fluorescent screen from the cathode surface due to repulsion between electron flows. In case of a doughnut-shaped hollow electron beam flux, high current density portion does not exist in the central portion of the electron beam flux, and repulsion between electrons is lessened, convergence is realized in a smaller area on the fluorescent screen and the electron beam spot diameter can be reduced.

(3) On the cathode surface 27, the electron radiation substance is not disposed in the strongest area of the electric field intensity and therefore, it becomes hardly exposed to ion attack in the vacuum operation and damage probability of the cathode electrode 1 due to discharge is lowered.

(4) When driving a conventional electron gun by high current, it becomes nearly a saturated current density state near the central axis of the electron beam on the cathode surface. Accordingly, the electron supply capacity is likely to deteriorate in this area and the cathode life is determined thereby. In the invention there is no electron supply from this area and electrons are radiated from a wider cathode region, and therefore, the current density load of the cathode is lessened and a longer life is expected.

(5) When driving a conventional electron gun by high current, it becomes nearly a saturated current density state near the central axis of the electron beam on the cathode surface and the electron radiation from this portion of the high current region becomes dull in sensitivity relative to changes in the cathode driving voltage. Namely, it is one of the causes of worsening of the drive characteristic in the high current region by electron radiation from the vicinity of the electron beam central axis Z of the cathode surface 27. In the invention, there is no electron supply from this area and electrons are radiated from the long ring-shaped protrusion portion or wider cathode region not reaching the saturated current density, so that the drive characteristic is improved in the high current region. Assuming that there is no electron radiation ideally from near the electron beam central axis, the results of a computer simulation become as shown in FIG. 10C.

Now it may be worried that the total cathode current would be lowered since no current is generated from the cathode central portion, but it can be compensated by widening the cathode electrode diameter.

For example, in an ordinary cylindrical symmetric cathode, supposing that the radius of the cathode current generating region at maximum current is R0, if electron is not generated from the region of its half radius,

current generating region of ordinary cathode:

S0=π·R0²

no electron generating region: SE=π R0^{2/4}

and when such electron not generated region is provided in the central portion,

supposing that the radius R of the current generating region is √5/2·R0,

the cathode current generating region of this system:

$$\begin{matrix}S0 = π \cdot {R}^{2} - π \cdot {R0}^{2 / 4} \\ = π \cdot {R0}^{2} \cdot ( 5 / 4 - 1 / 4 ) \\ = π \cdot {R0}^{2}\end{matrix}$$

hence a substantially equal cathode current generating region can be assured.

In other words, based on this simple and approximate calculation, taking a half hollow diameter of the current generating region radius of an ordinary cathode into account, it is enough to increase the current generating radius by 1.12 times (√5/2).

For the cathode electrode formed with a ring-shaped protrusion on the top of the electron radiation substance, the electron is radiated from the peak ridge of the ring-shaped protrusion surrounding the recess near the electron beam central axis when the current is low where the electric field intensity is reinforced, the current generating region spreads as descending from the peak ridge, the increase of the image points on the fluorescent screen of the CRT is suppressed, electron radiation is obtained only from the narrow region of the protrusion even at the time of high current, and the increase of the electron release region at the time of high current becomes small. This means the increase of the object points is small with respect to the main lens of the electron gun at the time of high current and widening of the image point on the CRT fluorescent screen is prevented.

Further, at higher current, the highest current density is observed at the ridge of the protrusion and while the conventional cathode is concentrated in the central point, this cathode is concentrated in the long ridge of the ring-shaped protrusion and it is not likely to be restricted by current density saturation due to the cathode material characteristics.

As an advantage of such cathode structure having the protrusion, the distance D_{gk} between G₁ 10 and cathode electrode 1 can be as minimized as possible or can be set closer to G₁ 10 or G₂ 11. In the conventional structure, if the distance is short, when turning on the heater, the sleeve or the like of the cathode structure is thermally expanded to contact with the cathode electrode 1, thereby inducing a failure of short-circuit.

Speaking of the cathode electrode 1 extending the protrusions 9k₁, 9k₂, 9k₃, . . . to the direction of the aperture 12 of the G₁ 10 and projecting the peak ridge of the protrusion from the aperture 12, it is also effective to lower the driving voltage of the cathode current.

Moreover, according to the cathode electrode, its manufacturing method, electron gun and cathode-ray tube of the invention, the crossover diameter can be reduced, and the electron beam spot diameter at the fluorescent screen can be narrowed. The convergence can be obtained in a smaller area than that of the conventional electron gun and probability of cathode damage due to discharge of ions or the like can be lowered. Further, as compared with the area-restricted cathode, electron radiation from wider region is possible where the current density load of the cathode is lessened, a longer life is expected, and also the cathode driving characteristic in the high current region can be improved.

### INDUSTRIAL APPLICABILITY

As described herein, according to the ring-shaped cathode structure (cathode electrode k) and its manufacturing method, it can be applied to display devices such as CRTs for televisions or computers and monitors for television receivers or computers.

1. (Amended) A cathode structure comprising:
a recess near the central portion of the top of an electron radiation substance, and plural concentric swollen protrusions surrounding said recess, wherein the heights of said plural concentric protrusions are made higher as departing from the concentric central axis.

2. (Amended) A cathode structure comprising:
a recess near the central portion of the top of an electron radiation substance, and plural concentric swollen protrusions surrounding said recess, wherein said protrusion is extended so as to penetrate through an aperture formed in a first control electrode, and the heights of said plural concentric protrusions are made higher as departing from the concentric central axis.

3. (Amended) A manufacturing method of a cathode structure comprising:
a step of forming a uniform electron radiation substance on an electron radiation substance forming member in advance, and
a step of disposing said electron radiation substance in a high humidity region,
wherein laser beams are irradiated to an area near the center or near the outer circumference on the top of said electron radiation substance, and a region which does not radiate electrons is formed at said electron radiation substance.

4. (Amended) A manufacturing method of a cathode structure, characterized in that an electron radiation substance of emitter impregnate type is used, a region of small porosity is formed near the center or near the outer circumference of the top of said electron radiation substance before emitter impregnation by laser beam radiation or by polishing where impregnation of emitter is prevented and a region which does not radiate electrons is formed in said emitter impregnate type electron radiation substance.

5. (Amended) A manufacturing method of cathode structure comprising:
a step of press-forming and sintering an emitter impregnate type electron radiation substance forming member which has a concave protrusion and forms a disk-shaped cathode structure, and
a step of disposing a substance which is not impregnated by the emitter near the center or near the outer circumference of said concave protrusion of said emitter impregnate type electron radiation substance, thereby forming a region which does not radiate electrons at said cathode structure.

6. (Amended) A manufacturing method of cathode structure comprising:
a step of pressing an emitter impregnate type electron radiation substance forming member together with a binder to form a disk-shaped porous base material having a concave protrusion in the central portion,
a step of sintering said porous base material,
a step of mechanical cutting said cathode structure except the top of said protrusion, and
a step of forming a region which is not impregnated by the emitter near the center or near the outer circumference of said protrusion of said disk-shaped porous base material, thereby forming a region which does not radiate electrons at said emitter impregnate type electron radiation substance.

7. (Amended) A cathode structure, characterized in that a uniform electron radiation substance is formed on an electron radiation substance forming member in advance, said electron radiation substance is disposed in a high humidity region, laser beams are irradiated to an area near the center or near the outer circumference on the top of said electron radiation substance, and a region which does not radiate electrons is formed at said electron radiation substance.

8. (Amended) A cathode structure, characterized in that an emitter impregnate type electron radiation substance is used, a region of small porosity is formed near the center or near the outer circumference of the top of said electron radiation substance before emitter impregnation by laser beam radiation or by polishing, thereby preventing impregnation of emitter and a region which does not radiate electrons is formed at said emitter impregnate type electron radiation substance.

9. (Amended) An electron gun, characterized in that a uniform electron radiation substance is formed on an electron radiation substance forming member in advance, said electron radiation substance is disposed in a high humidity region, laser beams are irradiated to an area near the center or near the outer circumference on the top of said electron radiation substance, and a region which does not radiate electrons is formed at said electron radiation substance.

10. (Amended) An electrode gun, characterized in that an emitter impregnate type electron radiation substance is used, a region of small porosity is formed near the center or near the outer circumference of the top of said electron radiation substance before emitter impregnation by laser beam radiation or by polishing, thereby preventing impregnation of emitter, and a region which does not radiate electrons is formed at said emitter impregnate type electron radiation substance.

11. (Amended) A cathode-ray tube incorporating an electron gun having a cathode, characterized in that a uniform electron radiation substance is formed on an electron radiation substance forming member in advance, said electron radiation substance is disposed in a high humidity region, laser beams are irradiated to an area near the center or near the outer circumference on the top of said electron radiation substance, and a region which does not radiate electrons is formed at said electron radiation substance.

12. (Amended) A cathode-ray tube incorporating an electron gun having a cathode, characterized in that an emitter impregnate type electron radiation substance is used, a region of small porosity is formed near the center or near the outer circumference of the top of said electron radiation substance before emitter impregnation by laser beam radiation or by polishing, thereby preventing impregnation of emitter, and a region which does not radiate electrons is formed at said emitter impregnate type electron radiation substance.
